(19) United States
(12) Patent Application Publication
(10) Pub. No.: US 2009/0305676 A1
(43) Pub. Date: Dec. 10, 2009

(54) COMMUNICATION DEVICE, AUTOMATIC MESSAGE REPLY METHOD AND SYSTEM

(75) Inventor: GUAN-PING ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/478,790

(22) Filed: Jun. 5, 2009

(30) Foreign Application Priority Data
Jun. 10, 2008 (CN) 200810302088.7

(51) Int. Cl. H04L 12/58

(52) U.S. Cl. 455/412.1

(57) ABSTRACT

A communication device includes an automatic message reply system. The automatic message reply system includes a presetting unit, a storing unit, a searching unit, an obtaining unit, and a reply unit. The presetting unit receives users operation to preset at least one set of key words, and at least one reply message corresponding to the at least one set of key words. The storing unit stores the at least one set of key words, and the at least one reply message corresponding to the at least one set of key words preset by the presetting unit. The searching unit searches whether a received message contains a set of key words. The obtaining unit obtains a preset reply message corresponding to the set of key words if the received message contains the set of key words. The reply unit sends a message obtained by the obtaining unit to the sender of the received message.

### BACKGROUND

1. Technical Field

The present disclosure relates to instant messaging and, particularly, to a method, system and communication device capable of providing automatic reply messages.

2. Description of Related Art

Instant Messaging (IM) is widely used in mobile phones now. It allows users to communicate with text, while the near real-time communication of IM is appealing, IM nonetheless has several drawbacks. For example, when the recipient steps away from his/her mobile phone or the recipient is attending an important meeting, the recipient may not be able to reply to the sender in time. Particularly to an organizer of a party, a junketing etc., the organizer usually needs to answer many messages asking nearly same problems. As a result, the organizer is usually busy in answering the nearly same problems to multiple senders.

What is needed, therefore, is an automatic message reply system and method to overcome or mitigate the above-described shortcomings.

### BRIEF DESCRIPTION OF THE DRAWINGS

Many aspects of the present communication device, automatic message reply method and system can be better understood with reference to the accompanying drawings. The components in the drawings are not necessarily drawn to scale, the emphasis instead being placed upon clearly illustrating the principles of the present communication device, automatic message reply method and system.

FIG. 1 is a flowchart of an automatic message reply method according to an exemplary embodiment.

FIG. 2 is a block diagram of a communication device according to an exemplary embodiment.

### DETAILED DESCRIPTION

Embodiments of the present disclosure will now be described in detail below, with reference to the accompanying drawings.

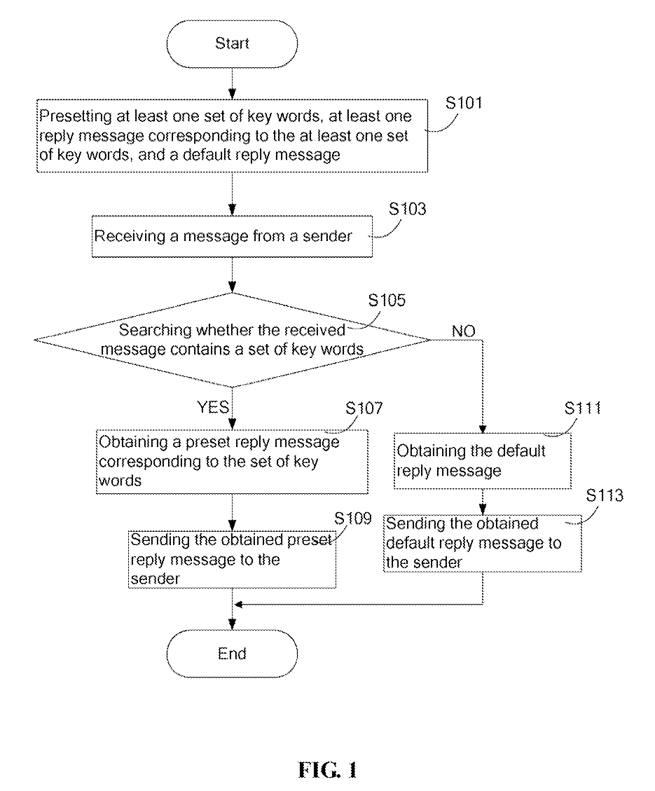

Referring to FIG. 1, a flowchart illustrating an automatic message reply method of a communication device is shown. The automatic message reply method includes the following steps.

Step S101: presetting at least one set of key words, at least one reply message corresponding to the at least one set of key words, and a default reply message. Each set of key words can contain one or more key words. For example, if you are an organizer of a party, the attendees may ask you the start time of the party, and the place of the party. So, you can preset a first set of key words containing “time” and “party”, and a second set of key words containing “where” and “party”. Corresponding to the first set of key words, you can preset a reply message, such as “the time of the party is 6:30 p.m., on Saturday”. Corresponding to the second set of key words, you can preset a reply message, such as “Lily's home”. The default reply message can include a description of a current activity or why the message cannot be replied promptly, for example, the default reply message can be “I am attending a meeting now”.

Step S103: receiving a message from a sender.

Step S105: searching whether the received message contains a set of key words. The message may not contain any sets of key words, contain only one set of key words, or contain a number of sets of key words.

Step S107: obtaining a preset reply message corresponding to the set of key words, if the received message contains the set of key words. If the received message contains a number of sets of key words, the obtained preset reply message can be selected from the group consisting of the preset reply messages corresponding to the number of sets of key words randomly.

Step S109: sending the obtained preset reply message to the sender.

Step S111: obtaining the default reply message if the received message does not contain any sets of key words. The default reply message can include a description of a current activity or why the message cannot be replied promptly.

Step S113: sending the obtained default reply message to the sender.

In other embodiments, in the step S101 of the automatic message reply method, the default reply message may not be preset. And if the received message does not include any sets of key words, no message will be replied to the sender.

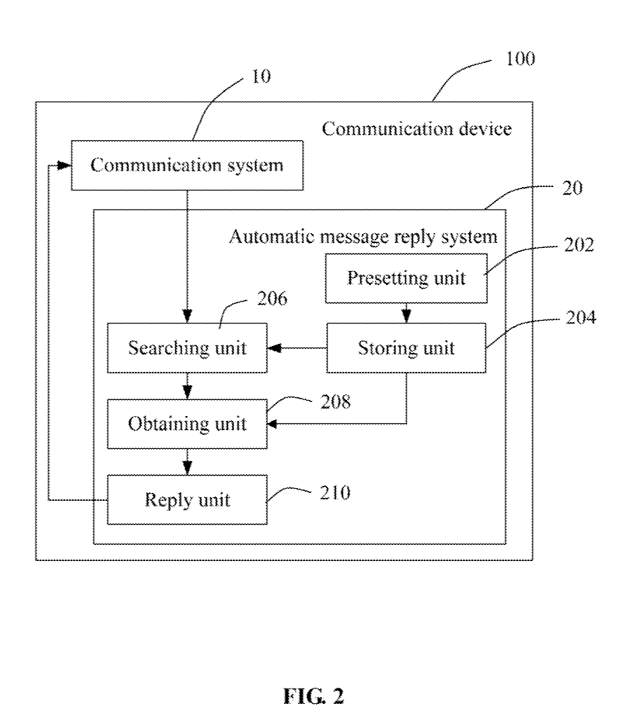

Referring to FIG. 2, a communication device 100, according to an exemplary embodiment, is shown. The communication device 100 includes a communication system 10 and an automatic message reply system 20. The communication device 100 has a normal mode and an automatic message reply mode. In the normal mode, the communication device 100 can only reply to messages manually. While, in the automatic message reply mode, the communication device 100 can reply to messages automatically.

The communication system 10 is used to exchange data with other communication device. In the present embodiment, the communication system 10 can be used for sending and receiving messages.

The automatic message reply system 20 includes a presetting unit 202, a storing unit 204, a searching unit 206, an obtaining unit 208, and a reply unit 210.

The presetting unit 202 receives users operation to preset at least one set of key words, at least one reply message corresponding to the at least one set of key words, and a default reply message.

The storing unit 204 stores the at least one set of key words, the at least one reply message corresponding to the at least one set of key words, and the default reply message preset by the presetting unit 202.

The searching unit 206 is configured for searching whether a received message contains a set of key words.

The obtaining unit 208 obtaining a preset reply message corresponding to the set of key words if the received message contains the set of key words, and obtaining the default reply message if the received message does not contain any sets of key words.

The reply unit 210 is configured for sending a message obtained by the obtaining unit 208 to the sender of the received message via the communication system 10.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A communication device comprising:
a communication system used to exchange data with other communication device; and
an automatic message reply system comprising:
a presetting unit for receiving users operation to preset at least one set of key words, and at least one reply message corresponding to the at least one set of key words;
a storing unit storing the at least one set of key words, and the at least one reply message corresponding to the at least one set of key words preset by the presetting unit;
a searching unit for searching whether a received message contains a set of key words;
an obtaining unit obtaining a preset reply message corresponding to the set of key words if the received message contains the set of key words; and
a reply unit for sending a message obtained by the obtaining unit to the sender of the received message via the communication unit.

2. The communication device as claimed in claim 1, wherein: the presetting unit further presets a default reply message; and the obtaining unit obtains the default reply message if the received message does not contain any sets of key words.

3. The communication device as claimed in claim 2, wherein the default reply message comprises a description of a current activity or why the message cannot be replied promptly.

4. The communication device as claimed in claim 1, wherein each set of key words comprises one or more key words.

5. The communication device as claimed in claim 1, wherein if the received message contains a number of sets of key words, the obtaining unit will randomly obtain a preset reply message from the group consisting of the preset reply messages corresponding to the number of sets of key words.

6. An automatic message reply method comprising:
presetting at least one set of key words, and at least one reply message corresponding to the at least one set of key words;
receiving a message from a sender;
searching whether the received message contains a set of key words, and obtaining a preset message corresponding to the set of key words if the received message contains a set of key words; and
sending the obtained message to the sender.

7. The automatic message reply method as claimed in claim 6, further comprising presetting a default reply message, and obtaining the default reply message if the received message does not contain any sets of key words.

8. The automatic message reply method as claimed in claim 7, wherein the default reply message comprises a description of a current activity or why the message cannot be replied promptly.

9. The automatic message reply method as claimed in claim 6, wherein each set of key words comprises one or more key words.

10. The automatic message reply method as claimed in claim 6, wherein if the received message contains a number of sets of key words, the obtained preset reply message will be selected from the group consisting of the preset reply messages corresponding to the number of sets of key words randomly.

11. An automatic message reply system of a communication device comprising:
a presetting unit for receiving users operation to preset at least one set of key words, and at least one reply message corresponding to the at least one set of key words;
a storing unit storing the at least one set of key words, and the at least one reply message corresponding to the at least one set of key words preset by the presetting unit;
a searching unit for searching whether a received message of the communication device contains a set of key words;
an obtaining unit obtaining a preset reply message corresponding to the set of key words if the received message contains the set of key words; and
a reply unit for sending a message obtained by the obtaining unit to the sender of the received message.

12. The automatic message reply system as claimed in claim 11, wherein: the presetting unit further presets a default reply message; and the obtaining unit obtains the default reply message if the received message does not contain any sets of key words.

13. The automatic message reply system as claimed in claim 12, wherein the default reply message comprises a description of a current activity or why the message cannot be replied promptly.

14. The automatic message reply system as claimed in claim 11, wherein each set of key words comprises one or more key words.

15. The automatic message reply system as claimed in claim 11, wherein if the received message contains a number of sets of key words, the obtaining unit will randomly obtain a preset reply message from the group consisting of the preset reply messages corresponding to the number of sets of key words.
